(19) United States
(12) Patent Application Publication
(10) Pub. No.: US 2026/0259404 A1
(43) Pub. Date: Sep. 3, 2026

(54) Multi-Wavelength Reconfigurable Optical Control Apparatus for Large-Scale Quantum Systems

(71) Applicant: Massachusetts Institute of Technology, Cambridge, MA (US)

(72) Inventors: Dirk Robert ENGLUND, Brookline, MA (US); Artur Hermans, Oxford (GB); Adrian Johannes Menssen, Cambridge, MA (US)

(73) Assignee: Massachusetts Institute of Technology, Cambridge, MA (US)

(21) Appl. No.: 19/489,164

(22) PCT Filed: Jun. 3, 2024
(86) PCT No.: PCT/US2024/032226

§ 371 Date: Dec. 1, 2025

Related U.S. Application Data
(60) Provisional application No. 63/505,991, filed on Jun. 2, 2023.

(51) Int. Cl. G02B 26/10; G06N 10/40

(52) U.S. Cl. CPC G02B 26/105; G06N 10/40

(57) ABSTRACT

Many quantum systems, including arrays of trapped atoms, trapped ions, and color centers in solid-state hosts, are controlled with optical control signals. As quantum systems increase in size to thousands of channels or more, however, it can be challenging to generate enough optical control signals to control them. A multi-wavelength reconfigurable optical control apparatus uses lasers, high-speed modulators, a reconfigurable spatial light modulator (SLMs), and a fast beam scanner to address thousands of qubits. The lasers generate beams at the qubits' resonant wavelengths; the modulators modulate the beams with control pulses at gigahertz rates; the SLM re-projects the beams into a geometry matched to the quantum operation and the geometry of the qubit array; and the beam scanner scans the beams across the qubit array at kilohertz to megahertz rate. This enables the control apparatus to address CN the entire array before the qubits' coherence time has elapsed.

### CROSS-REFERENCE TO RELATED APPLICATION(S)

This application claims the priority benefit, under 35 U.S.C. 119(e), of U.S. Application No. 63/505,991, filed Jun. 2, 2024, which is incorporated herein by reference in its entirety for all purposes.

### BACKGROUND

Quantum information processing involves performing quantum gate operations on qubits, which are the basic units of quantum information. A qubit can be encoded in the energy levels of a trapped neutral atom (e.g., an alkali atom), trapped ion (e.g., a calcium ion), or color center in a solid-state host (e.g., nitrogen vacancy in diamond). Qubits can be arranged in one-dimensional (1D), two-dimensional (2D), or three-dimensional (3D) arrays and entangled with neighboring qubits for performing different quantum information processing tasks.

### SUMMARY

Scaling a quantum system to a larger size is a major challenge in the quest for widely useful quantum information processing systems. One of the main obstacles lies in the development of optical and electrical control devices for large-scale quantum systems. The present technology provides optical quantum control for quantum systems with large numbers (e.g., thousands) of qubits. Specifically, we introduce a multi-wavelength reconfigurable optical control apparatus for large-scale quantum systems.

Many quantum systems are controlled with optical control signals, including neutral atoms, ions, and color centers in diamond or other materials. Optical quantum control devices can be characterized by (C1) ultraviolet (UV) to near-infrared (NIR) wavelength operation, (C2) large channel counts (beyond thousands of channels), (C3) high-extinction-ratio modulation (e.g., >30 dB), (C4) fast switching times (e.g., on the order of nanoseconds), and (C5) high repeatability (for low gate errors). First steps have been taken in the realization of devices fulfilling (part of) these criteria. Yet, there are still many challenges ahead, in particular when it comes to scaling beyond thousands of optical control channels (i.e., >1000 neutral atoms, ions, color centers, etc. to control), criterion C2.

The present technology can reach effective channel counts up to O(10⁶), while also fulfilling the other criteria laid out above. This technology can take the form of an apparatus for controlling qubits in an array of qubits, which may include about 1,000 qubits to about 1,000,000 qubits. Such an apparatus can include lasers, modulators, one or more spatial light modulators (SLMs), and a beam scanner. In operation, the lasers emit laser beams in different wavelength channels. The modulators, which are in optical communication with the lasers, temporally modulate the laser beams to perform a quantum operation on at least some of the qubits in the array of qubits. The SLM, which is in optical communication with the modulators, spatially modulates the laser beams based at least in part on the quantum operation. And the beam scanner, which is in optical communication with the SLM, scans the laser beams across the array of qubits (e.g., in a stepwise fashion) at a scan rate faster than a reciprocal of a coherence time of the qubits.

The lasers can be configured to emit the laser beams at wavelengths resonant with atomic transitions of the qubits.

The modulators can be configured to temporally modulate the different wavelength channels independently of each other. The modulators can comprise micro-ring resonators arrayed along and evanescently coupled to a waveguide. The modulators can be configured to temporally modulate the laser beams at a rate of about 100 kHz to about 10 GHz, which case the beam scanner can be configured to scan the laser beams across the array of qubits at a rate of about 1 kHz to about 1 MHz.

The SLM can be configured to project the laser beams into arrays or columns of laser beams spaced apart in a scan direction of the beam scanner by a spacing based on a lattice constant of the array of qubits. In some cases, the spacing is equal to the lattice constant of the array of qubits and the apparatus is configured to perform a two-qubit gate on nearest-neighbor qubits in the array of qubits. If desired, the SLM can vary the spacing between the columns of laser beams between scans of the columns of laser beams.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. Terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a block diagram of a multi-wavelength reconfigurable optical control apparatus for a large-scale quantum system.

FIG. 2 illustrates an implementation of a multi-wavelength reconfigurable optical control apparatus.

FIG. 3 shows an on-chip modulator array (with 1000 channels) combined with a spatial light modulator (SLM) (for beam transformation/reconfiguration) and a beam scanner to serially address O(10⁶) atoms with two parallel sheets of light (columns of beams).

FIG. 4A illustrates a multi-wavelength ring-based modulator with critically coupled all-pass micro-ring resonators suitable for use in a multi-wavelength reconfigurable control apparatus.

FIG. 4B illustrates a multi-wavelength ring-based modulator with critically coupled add/drop micro-ring resonators suitable for use in a multi-wavelength reconfigurable control apparatus.

FIG. 4C illustrates a ring-assisted Mach-Zehnder modulator suitable for use in a multi-wavelength reconfigurable control apparatus.

FIG. 5 illustrates cluster state generation using the beam scanner of FIG. 3 to scan sheets of control light along an array of atoms, entangling atoms within the light sheets.

FIG. 6 illustrates a single-qubit gate for a Rydberg atom.

FIG. 7A illustrates a two-qubit gate for a Rydberg atom with a transition to a Rydberg state through an intermediate state.

FIG. 7B illustrates a two-qubit Rydberg blockade gate.

FIG. 8 illustrates a logarithmic overhead entanglement process performed on a 1D array of atoms by a multi-wavelength reconfigurable optical control apparatus.

FIG. 9 illustrates a logarithmic overhead entanglement process performed on a 2D array of atoms by a multi-wavelength reconfigurable optical control apparatus.

FIG. 10A illustrates establishment of nearest-neighbor connections among atoms in a chain of trapped atoms using an inventive multi-wavelength optical control apparatus.

FIG. 10B illustrates reshuffling and entanglement of the atom chain of FIG. 10A using an inventive multi-wavelength optical control apparatus.

FIG. 10C illustrates the atom chain in a cluster state established with three of the reshuffling and entanglement steps shown in FIG. 10B.

### DETAILED DESCRIPTION

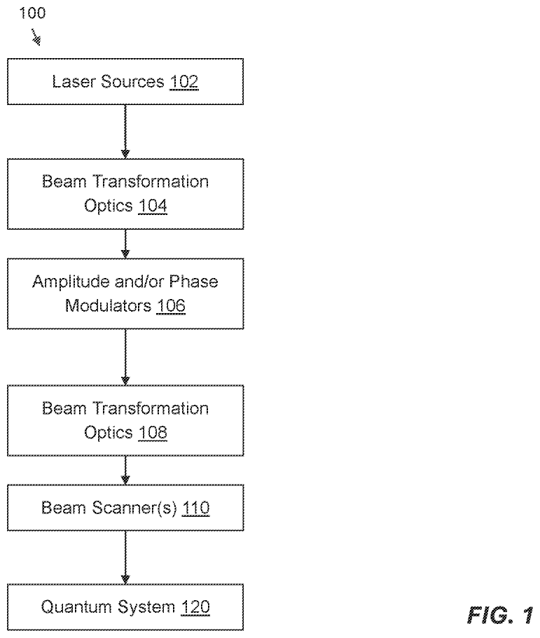

FIG. 1 illustrates a multi-wavelength reconfigurable optical control apparatus 100, or control apparatus 100 for short, for a large-scale quantum system. The control apparatus 100 includes a set of laser sources 102 that emit light at a variety of wavelengths, e.g., from the ultraviolet (UV) to the near-infrared (NIR) regions of the electromagnetic spectrum, depending on the transitions being targeted in the quantum system. Beam transformation optics 104, such as one or more liquid crystal spatial light modulators (SLMs), transform the laser beams to achieve efficient coupling into the photonic integrated circuit(s) containing high-speed amplitude and/or phase modulators 106. Liquid crystal SLMs can generate spot arrays with O(10³) spots. The beam transformation optics 104, which may also include passive optical elements, such as lenses, mirrors, and/or beam splitters, can be designed to match the spatial mode profiles of these spots to the spatial mode profiles of the input couplers of the photonic integrated circuits (these input couplers can, for example, be grating or edge couplers, with typical mode diameters of O(10°) to O(10¹) m).

After the beams have been coupled into the photonic integrated circuits, they are modulated at high speeds (e.g., MHz to GHz speeds) by the on-chip modulators 106. (The modulators 106 could be integrated into a single chip with the laser sources 102, possibly at the expense of more challenging thermal management and fewer channels.) The on-chip modulators 106 can, for instance, be based on the Pockels effect, the piezoelectric effect, the quantum-confined Stark effect, or the plasma dispersion effect. An on-chip modulator array may include O(10¹) channels (modulators) and possibly up to O(10³) channels (modulators). These on-chip modulators 106 can be designed to fulfill criteria C1, C3, C4, and C5. Unfortunately, scaling beyond O(10³) channels to fulfil criterion C2, large channel counts, is challenging.

Additional beam transformation optics 108 redirect and shape the modulated laser beams emitted by output couplers (e.g., grating or edge couplers) on the photonic integrated circuit that contains the modulators 106. These beam transformation optics 108 may include one or more additional liquid crystal SLMs as well as other passive optical components, such as lenses, mirrors, and/or beam splitters. The beam transformation optics 108 can rearrange or reshape the modulated laser beams so that they simultaneously address different columns (rows) of an array of qubits 120 that is scanned in a column-wise (row-wise) fashion.

One or more beams scanners 110, such as micro-electromechanical systems (MEMS) mirrors, galvanometer-scanning mirrors, or acousto-optic deflectors (AODs), scan the modulated laser beam(s) across an array of qubits, such as neutral atoms, ions, or color centers in a solid-state material, in the quantum system 120. The beam scanner(s) 110 can be implemented as a single device, such as a tip-tilt MEMS mirror, that can scan in two axes, or a pair of cascaded devices, such as a pair of galvanometer-scanning mirrors, that can scan the beam along different (e.g., orthogonal) axes. The beam scanner(s) scan the beams across the qubit array faster than the qubits' coherence time, which is the period over which the qubits can maintain their complex quantum states. This makes it possible for the control apparatus 100 to address large numbers of qubits (e.g., >1000 qubits), fulfilling criterion C2, large channel counts.

The number of qubits in the quantum system 120 is limited by the number of resolvable modes M of the beam scanner 110 (e.g., typically on the order of 1000) and the number of on-chip modulators (e.g., on the order of 1000). If there are 1000 on-chip modulators 106 and the beam scanner 110 can resolve 1000 modes, this implies that the quantum system 120 could have at least 1,000 qubits to on the order of 1,000,000 qubits arranged in a rectangular (square) array, with each resolvable mode mapping to one column (or row) of the array and each modulator mapping to one row (column) of the array. Depending on the gate, of course, multiple modulators can be mapped to a single row (column) of the array.

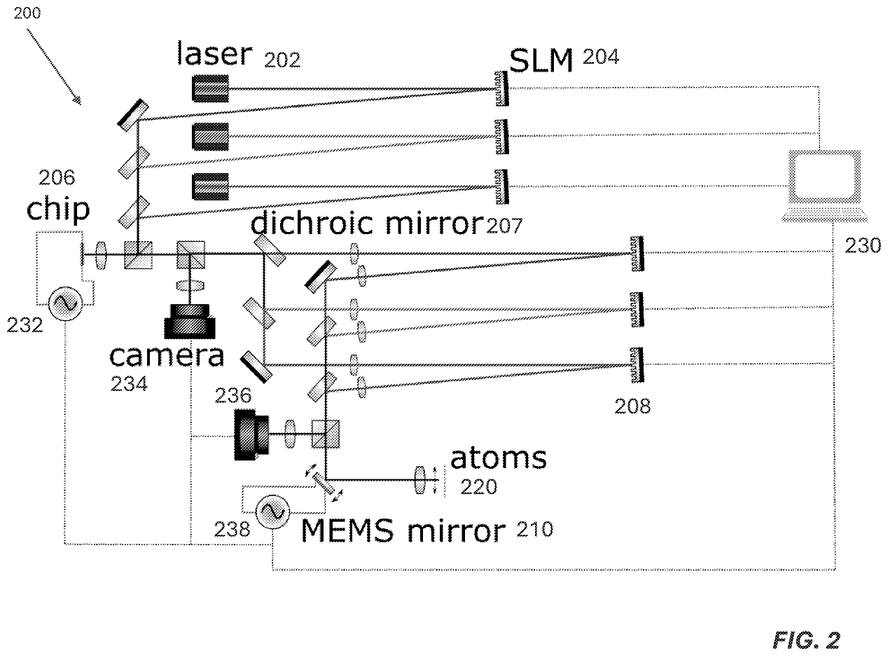

FIG. 2 shows an example multi-wavelength reconfigurable optical control apparatus 200 for the array of qubits 220 (e.g., neutral atoms, ions, or color centers). It includes several lasers 202 (e.g., 1-10 lasers), each of which can emit light at a different wavelength, with the wavelength(s) selected based on the transitions being addressed in the atoms 220 or color centers used as the qubits. For rubidium atoms, the wavelengths may be 780 nm and 480 nm, whereas for calcium ions, the wavelengths may be 397 nm and 729 nm. The wavelengths typically lie in the UV to NIR range.

The lasers 202 can be discrete or integrated devices and can be fixed or tunable. For instance, the lasers 202 can be external-cavity diode lasers (ECDLs), which are available with emission wavelengths over a large portion of the UV to NIR wavelength band, can emit relatively high powers, have narrow linewidths, and are tunable, robust, and reliable. Tunability makes it possible to tune the laser wavelength, which may vary by a few nanometers from laser to laser, to the transition wavelength of the qubit. The laser linewidth depends on the linewidth of transition being targeted and may range from MHz to Hz.

One or more reflective SLMs 204 controlled by a processor, controller, or computer 230 spatially modulate the beams emitted by the lasers 202. In this example, there is one SLM 204 for each laser 202; in other examples, different lasers may illuminate different portions of a single SLM. The SLMs 204 shape the laser beams for more efficient coupling into a photonic integrated circuit chip 206 containing an array of high-speed amplitude and/or phase modulators. Dichroic mirrors and a beam splitter combine the spatially modulated beams reflected from the SLMs 204 and couple them into the photonic integrated circuit chip 206.

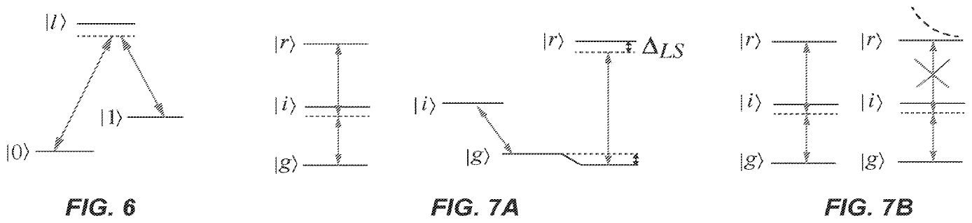

The modulators in the photonic integrated circuit chip 206 are driven by a radio-frequency (RF) signal source 232, such as an arbitrary waveform generator, pulse pattern generator, or synthesizer, that is controlled by the processor 230. The modulators modulate the phases and/or amplitudes of the laser beams, e.g., at rates of megahertz to gigahertz, to provide control pulses for single- and two-qubit quantum gates like those described below with respect to FIGS. 6, 7A, and 7B. Output couplers in the photonic integrated circuit chip 206 emit the modulated beams (control pulses) into free space, where a beam splitter directs a portion of the combined beams to a camera 234 for aligning the laser beams to the photonic integrated circuit chip 206 and the rest to cascaded dichroic mirrors 207, which separate the beams by wavelength.

Another set of reflective SLMs 208 controlled by the processor 230 spatially modulate the wavelength-demultiplexed control pulses, with one SLM 208 per wavelength. This allows control pulses at different wavelengths to be spatially modulated independently. This spatial modulation determines which qubits (atoms 220) are addressed by the control pulses. More dichroic mirrors combine the spatially modulated control pulses. Another beam splitter directs a portion of the combined, spatially modulated control pulses to a camera 236 coupled to the processor 230 and used for diagnostic and/or control purposes, e.g., in a feedback loop to control the spatial modulation imparted by the SLMs 208.

The beam splitter transmits the rest of the combined, spatially modulated control pulses to a MEMS mirror 210 that scans the combined, spatially modulated control pulses across the atoms 220 as described below, e.g., at kilohertz to megahertz rates. The MEMS mirror 210 is driven by another RF signal generator 238 coupled to and controller by the processor 230.

The control apparatus 200 may also include other components, including lenses, mirrors, beam splitters, filters, and/or prisms not shown in FIG. 2 for directing and shaping the beams from the lasers 202. For example, lenses can expand and collimate the beams emitted by the lasers 202. Spatial filters can remove unwanted spatial modes. Mirrors can reflect beams propagating between other components. It can also include or be coupled to components associated with the quantum system 220, such as a cryogenic cooler for a quantum system formed of color centers in a solid-state host (e.g., nitrogen or tin vacancies in diamond) or a magneto-optical trap or all-optical trap for trapping neutral atoms or ions. Alternatively, the control apparatus 200 can both illuminate the neutral atoms or ions with control pulses and trap and move the neutral atoms or ions.

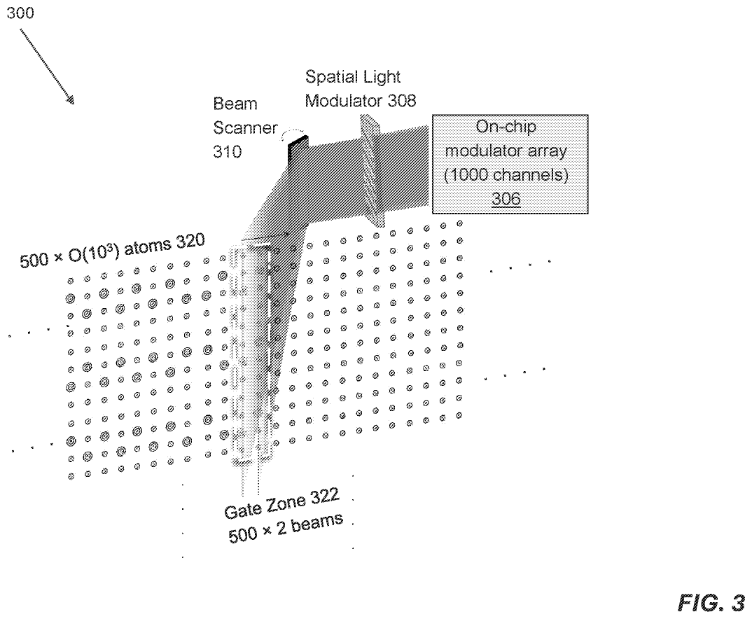

FIG. 3 illustrates beam-scanning technology suitable for fulfilling criterion C2, large channel counts, in the multi-wavelength reconfigurable optical control apparatus 200 of FIG. 2 or other similar apparatus. An on-chip modulator array 306 with a large number of channels (e.g., 1000 channels) emits an array of modulated beams (control pulses) into free space for controlling a quantum system in the form of neutral atoms 320 (e.g., cold alkali atoms) arrayed on a square lattice. This array may include O(10⁶) atoms, e.g., arranged in an array of 500 atoms by O(10³) atoms.

An SLM 308 transforms the beams (control pulses) emitted by the on-chip modulator array 306 to a geometry better matched to the targeted neutral atoms 320 and to the quantum gate being applied to those neutral atoms 320. (The arrangement and fill factor of the on-chip output couplers typically does not match the arrangement and fill factor of the quantum system.) A high-speed beam scanner 310, such as a MEMS mirror, galvanometer-scanning mirror, or AOD, scans the spatially modulated beams from the SLM 308 across the array of neutral atoms 320 at kilohertz to megahertz rates. By scanning the modulated beams so quickly, the beam scanner can serially address O(10⁶) neutral atoms 320 within their coherence time, which can vary from microseconds to minutes (e.g., on the order of 100 ρs) depending on the neutral atom 320 and energy level(s).

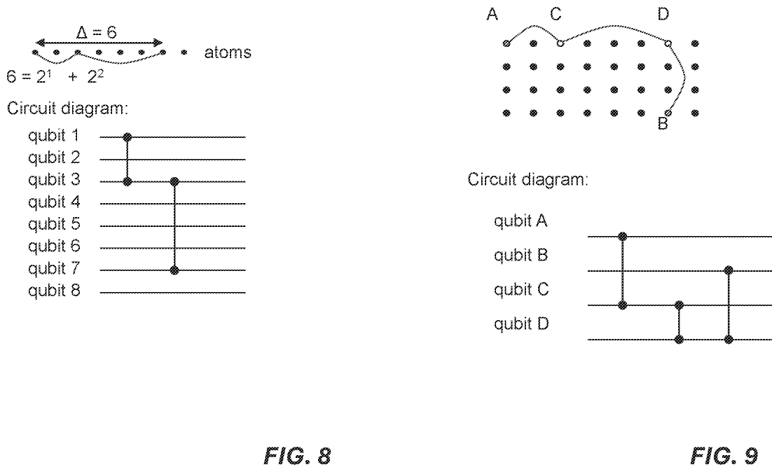

In the example shown in FIG. 3, the SLM 308 reshapes the control pulses emitted by on-chip modulator array 306 (e.g., an array of 1000×1 beams) into an array of 500×2 beams, with the beams spaced apart by an integer multiple of the lattice constant of the array of neutral atoms 320. (This configuration of two columns of beams spaced apart by the lattice constant of atom array could, for instance, also be generated by using two chips to emit 500 modulated, polarized beams each and combining the beams from both chips with a polarizing beam splitter (PBS).) The beam scanner 310 scans this array of 500×2 beams over the array of neutral atoms 320 to create a moving qubit gate zone in which gates can be enacted on adjacent atoms. As explained below with respect to FIGS. 8-10, the spacing between the arrays of beams and hence the size and shape of the moving qubit gate zone can be varied from scan to scan or even during a scan. Other configurations are also possible; for example, the SLM 308 and beam scanner 310 can illuminate more than two columns at a time to perform multi-qubit gates (where multi, in this instance, means more than two).

Scanning the modulated beams across the array of neutral atoms 320 with the high-speed beam scanner 310 effectively increases the number of optical control channels far beyond the number of channels in the on-chip modulator array 306 (typically O(10³)). In essence, beam scanning enables control of O(N) atoms using only O(√N) on-chip modulators (wavelength channels). The control apparatus provides this O(√N) savings because it can address O(√N) columns (or rows) of qubits with the qubits' coherence time; that is, the control apparatus can operate with one modulator per column (or row) instead of one modulator per qubits thanks to the beam scanner 310. This approach saves costs, since these on-chip channels are expensive, and increases the optical power reaching the atoms given a fixed laser power budget (which can lead to shorter gate times), since the power is divided over O(√N) atoms, not O(N) atoms.

### Beam Scanners

The number of resolvable modes or spots M along the scanning direction is given by

$$M = \frac{Δα}{δα} ,$$

where Δα is the optical angle scan range and δα is the angular divergence of the beams. The angular divergence is determined by the beam diameter D (limited by the diameter of the scanner) and the wavelength, λ:

$$δ α = \frac{4 λ}{π D} .$$

TABLE 1 (below) lists the specifications for a selection of commercially available beam scanners. The number of resolvable spots goes up to several 1000s, thereby enabling addressing of O(10³) columns and/or rows of atoms (e.g., using the arrangement shown in FIG. 3).

TABLE 1
Specifications of example galvanometers,
MEMS mirrors, and AODs.

| | | Δα | D | M at | fᵣ | |
|---|---|---|---|---|---|---|
| Scanner type | Supplier | (°) | (mm) | 780 nm | (kHz)^{a} | τ (μs)^{b} |
| Galvanometer | Novanta | 26 | 9.25 | 4227 | 4 | |
| | Photonics | | | | | |
| Galvanometer | Novanta | 26 | 5 | 2285 | 8 | |
| | Photonics | | | | | |
| Galvanometer | Novanta | 10 | 5 | 879 | 12 | |
| | Photonics | | | | | |
| MEMS | Maradin | 45 | 1 | 791 | 11.25 | |
| MEMS | Hamamatsu | 40 | 1.23 | 865 | 29.3 | |
| AOD | Isomet | 2 | 9 | ~400 | | 13.5 |
| AOD | AA | ~2 | 7.5 | ~300 | | ~12 |
| | Optoelectronic | | | | | |

^{a}Resonance frequency; only applies to galvanometers and MEMS mirrors.
^{b}Access time; applies to AODs.

The electrical drive signal for the beam scanner, and thereby the beam trajectory, can be shaped as desired. The beam scanner can, for instance, be driven in a stepwise fashion such that it steps from column to column (or row to row) of the array and dwells on each column (or row) long enough to cause the desired transition. Put differently, the dwell time depends on the gate duration, which depends on the type of qubit and is typically at least 10 ns. The number of control pulses/gate operations performed on each qubit during a single dwell period depends on the dwell time (scan speed) and the gate duration. Typical response times for the scanners in TABLE 1 lie in the O(10¹) to O(10²) s range. Driving the beam scanner with a sinusoidal drive signal can produce faster scanning over the entire quantum system. In the case of a galvanometer or MEMS mirror, a sinusoidal signal at the beam scanner's resonance frequency fᵣ enables driving at lower voltages for a fixed angular range.

Scanning abeam over O(10³) atoms in O(10¹) to O(10²) s gives a beam dwell time per atom of O(10¹) to O(10²) ns. Response times of that order of magnitude can easily be achieved with on-chip modulators, which can operate with modulation rates of megahertz to gigahertz. If longer dwell times are desired, e.g., if the gate times are longer than O(10¹) to O(10²) ns, the scan speed can be reduced. Typically, the beam scanner should scan the beam(s) across the entire quantum system faster than the quantum system's coherence time, which can vary from microseconds to minutes depending on the quantum system. The scan speed can be set according to the quantum system under consideration.

### On-Chip Modulators

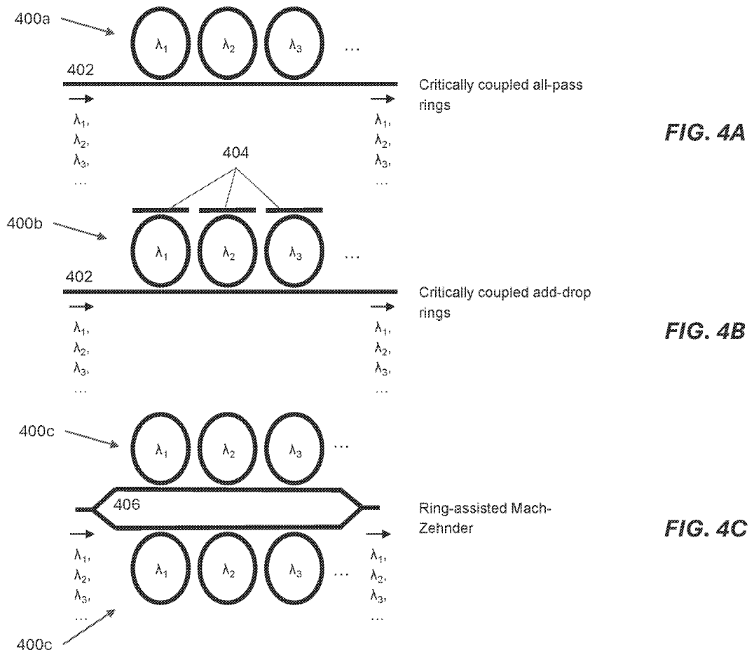

FIGS. 4A-4C show several compact architectures for high-speed, multi-wavelength, ring-based modulators suitable for use in a multi-wavelength reconfigurable optical control apparatus like those shown in FIGS. 1-3. Each modulator includes ring resonators 400, also called a micro-ring or ring, arranged in series along a waveguide (e.g., a bus waveguide 402 as in FIGS. 4A and 4B). Each ring resonator 400 is resonant at a different wavelength such that together, the ring resonators 400 are resonant at all of the wavelengths of the beams (control pulses) used to control the quantum system. This enables the modulators to modulate each wavelength channel independently of the other wavelength channels. A typical quantum control experiment uses O(10⁰) to O(10¹) different wavelengths in the UV to NIR range, so each modulator can contain O(10⁰) to O(10¹) rings (for simplicity, FIGS. 4A-4C show only a few rings). The rings 400 and waveguides are fabricated in a semiconductor substrate (e.g., a silicon substrate). The waveguides guide light from input couplers and to output couplers (not shown), such as broadband edge couplers, 3D printed micro-optics, and/or grating couplers. If desired, these input and output couplers can be optimized for different wavelengths and linked to waveguide(s) with broadband wavelength combiners.

The modulator in FIG. 4A includes all-pass ring resonators 400a that are critically coupled to a bus waveguide 402 for an output with a high extinction ratio. Each all-pass ring resonator 400a is resonant at a different wavelength (λ, λ₂, λ₃, . . . ). Tuning the resonance, e.g., by heating the ring 400a or applying a voltage to electro-optic material embedded in the ring 400a, modulates the phase of the beam coupled to that ring 400a.

FIG. 4B shows a modulator with add/drop ring resonators 400b that are critically coupled to both a bus waveguide 402 and to one or more output waveguides 404. Again, each add/drop ring resonator 400a is resonant at a different wavelength (λ, λ₂, λ₃, . . . ). Tuning a ring resonator's resonance wavelengths changes whether that ring resonator couples light back into the bus waveguide 402 or into the output waveguide 404 instead. This produces an amplitude modulation in the beams propagating through the bus waveguide 402 and the output waveguide 404.

FIG. 4C shows a modulator with symmetric add/drop rings 400c, also called a (dual-) ring-assisted Mach-Zehnder interferometer. This modulator includes two sets of add/drop rings 400c, each of which is evanescently coupled to a different arm of a Mach-Zehnder interferometer 406, for a total of two rings 400c per wavelength channel. (The beam splitters/combiners in the Mach-Zehnder interferometer 406 are drawn as simple Y-splitters, but these can also be directional couplers or multimode interferometers (MMIs).) This gives the dual-ring-assisted Mach-Zehnder interferometer more degrees of freedom, making them suitable for achieving large extinction ratios despite possible fabrication variations. It can also modulate the amplitude and phase of each wavelength channel independently.

### Quantum Control

An inventive multi-wavelength reconfigurable optical control apparatus can be used for any quantum system that uses optical control, e.g., neutral atoms, ions, color centers, or quantum dots. The quantum interactions in the system can be implemented through a variety of approaches, such as Rydberg interactions, motional gates via Coulomb interactions, or optically heralded entanglement. For example, an inventive multi-wavelength reconfigurable optical control apparatus can be used to construct a cluster state, which is a type of highly entangled state of multiple qubits. Cluster states are examples of computational resource states for quantum computing architectures.

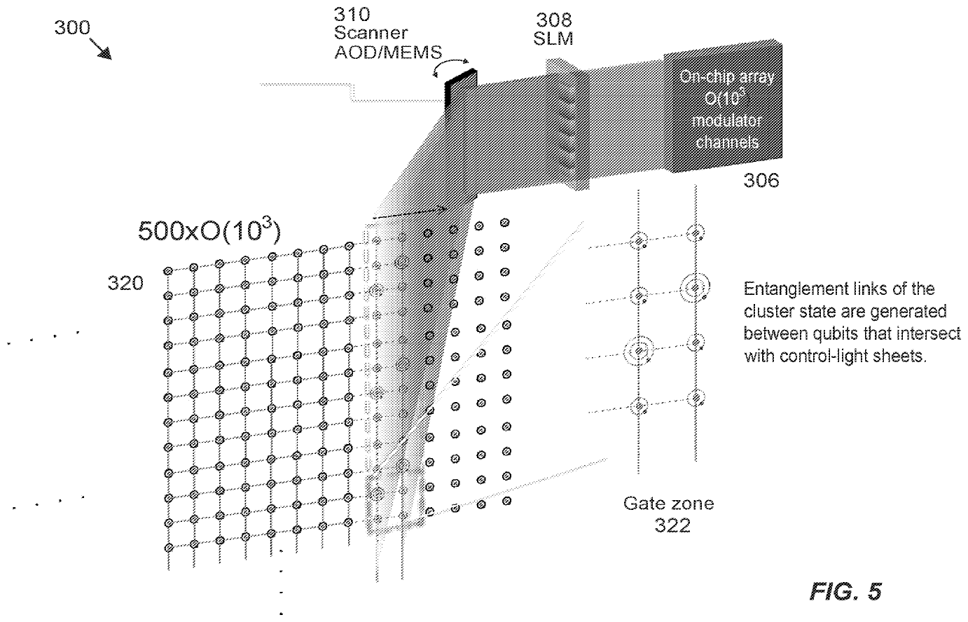

FIG. 5 illustrates how to use the beam-scanning architecture of FIG. 3 to generate a 2D entangled state using Rydberg blockade interactions in the array of neutral atoms 320. For simplicity, we assume the blockade radius is one lattice spacing (i.e., the distance between a pair of adjacent neutral atoms in the array of neutral atoms 320). Each qubit is encoded in the hyperfine ground states of a corresponding neutral atom, with two-qubit interactions mediated through strong dipole-dipole coupling of highly excited Rydberg states.

A light sheet addressing a single column of N atoms is formed by N individual light beams that are individually controlled and modulated in time. Here, each spot may contain one or more wavelengths, each of which a phase and an amplitude that can be controlled independently (e.g., by using an array of MZI-coupled ring modulators as illustrated in FIG. 4C). For example, controlling the phases and amplitudes of two beams at wavelengths separated by the hyperfine splitting of the ground state of an alkali metal, such as ⁸⁷Rb, allows the implementation of single-qubit gates on a ground state (e.g. 5S1/2 F=1=|0>; F=2=|1>) hyperfine-encoded qubit using a two-photon Raman transition via an intermediate state such as the 5P1/2 (3/2) of ⁸⁷Rb shown in FIG. 6. The control apparatus can implement arbitrary single-qubit operations on every atom by sweeping the light sheet along all M columns of the qubit array.

FIGS. 7A and 7B illustrate two-qubit gates that can be realized between neighboring atoms using two light sheets. Each beam contains light at the wavelengths for a ground state |g> to Rydberg state |r> transition as shown in FIG. 7B. At least one of these wavelengths should be modulated in amplitude and phase to enable a selective transition to the Rydberg state. A two-qubit CZ gate can be realized by the Rydberg blockade gate. Neighboring atoms in a single column can be entangled simultaneously using a single light sheet by nearest-neighbor pair-wise exciting them to the Rydberg state from the ground state, as illustrated in FIG. 7B. Two light sheets can generate entanglement between nearest neighbors in different columns, where for each entangling operation two channels are modulated, one in each column at nearest neighbor positions.

An inventive control apparatus can generate entanglement beyond nearest-neighbor distances using the light sheets to also trap the atoms by controlling far off resonant dipole trapping light. The control apparatus can then, for example, move an entire column of atoms next to a different column and execute an entanglement operation (e.g., as described below with respect to logarithmic overhead entanglement). Put differently, a background/static array of dipole traps can trap all the atoms, and trapping potentials generated by the control apparatus can pick up and drop off large groups of atoms from the static trapping array.

### Logarithmic Overhead Entanglement

An inventive multi-wavelength reconfigurable optical control apparatus can also be used to perform operations between any two qubits in a quantum system in a sequential fashion. This process is called logarithmic overhead entanglement and can be achieved by sweeping a set of modulated beams over the quantum system and dynamically reconfiguring (e.g., using the SLM 308 shown in FIG. 3) the beam configuration during the sweep or after each pass over the entire quantum system. Consider, for instance, the regularly spaced 2D array of neutral atoms 320 addressed by two sweeping columns/sheets of modulated beams as illustrated in FIG. 3. After each pass over the array of neutral atoms 320, the SLM 308 can reconfigure the spacing between the two columns of beams. For instance, the spacing can start at a spacing of 1=2⁰ lattice constants, followed by a spacing of 2¹ lattice constants for the second pass, 4=2² lattice constants for the third pass, 8=2³ lattice constants for the fourth pass, and so on.

Consider performing a two-qubit gate on two atoms in the array spaced by Δ lattice constants along the beam-scanning direction. Δ can be expressed in the base-2 numeral system or equivalently written as a weighted sum of powers of 2:

$$Δ = {\sum }_{j = 0}^{floor ( {log}_{2} ( Δ ) )} {b}_{j} {2}^{j} ,$$

with bⱼ∈{0,1}. The control apparatus can perform an operation between the two qubits spaced by Δ by sequentially performing operations between qubits spaced by 2^{j} until it has bridged the total distance Δ (e.g., start with beam spacing of one lattice constant and multiply the beam spacing by two after every pass over array).

FIG. 8 illustrates this process for two atoms, atoms 1 and 7, separated by a spacing of Δ=6 (=110 in binary) lattice constants in a 1D array of atoms. During the first pass, the control apparatus performs a quantum operation on atoms 1 and 3 with a pair of beams separated two lattice constants. During the second pass, the control apparatus performs a quantum operation on atoms 3 and 7 with a pair of beams separated four lattice constants, completing the connection between atoms 1 and 7 with atom 3 acting as a bridge as shown in the circuit diagram in the lower half of FIG. 8. Practically, implementation of this process may be limited by the physical quantum interaction mechanism. Rydberg interactions are typically negligible for distances greater than a couple of lattice constants, whereas optically heralded entanglement can operate over greater distances.

FIG. 9 illustrates sequential operations for atoms A and B in different rows and columns of a 2D lattice. Using the sequential procedure outlined above with respect to FIG. 8, the control apparatus performs sequential operations between atoms A and C and then between atoms C and D, all of which are in the same row oriented along the beam-scanning direction. Atom D is in the same column as atom B, so both atoms D and B can be addressed simultaneously with the same sheet of light in the next pass. This completes the sequential procedure to perform an operation between atom A and B.

The process shown in FIGS. 8 and 9 is called logarithmic overhead entanglement because the intermediate steps for performing an operation between any two qubits creates some overhead. Considering a quantum system with O(N) atoms arranged in O(√N) columns, the number of steps (i.e., the number of scans/passes over the quantum system to entangle the atoms) scales as log₂(√N). Logarithmic overhead entanglement works especially well for long-range quantum interactions (e.g., optically heralded entanglement implemented for an array of chip-based color centers using beam splitters and photodetectors for entanglement) but can be more challenging to implement for short-range interactions (e.g., Rydberg interactions).

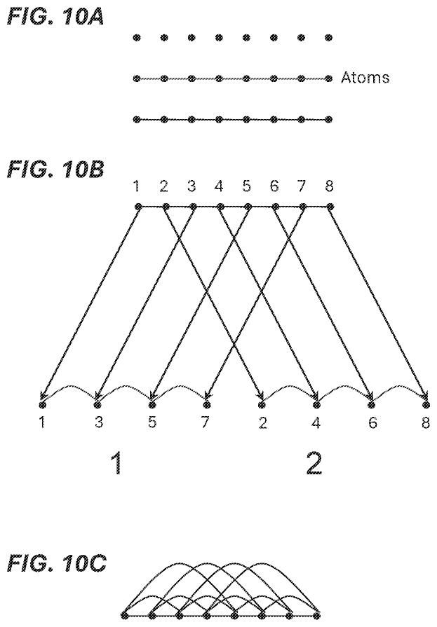

FIGS. 10A-10C illustrate a logarithmically scaling quantum process using only nearest neighbor interactions, such as arrays of neutral atoms with Rydberg interactions, in a quantum system with qubits that can be physically moved, such as trapped atoms or trapped ions. These qubits can be moved with the control apparatus and/or with separate trapping beams. This process exploits the optical control provided by an inventive control apparatus for dynamic resorting of the atoms as well as entanglement link generation. This process can create a state with nonlocal connectivity, such as a cluster state. Nonlocal connectivity is especially useful for protocols such as quantum gate teleportation, where gates executed between remote qubits use local operations and an entanglement link.

FIG. 10A illustrates a first step in creating a cluster state using this logarithmically scaling quantum process on a linear chain of L trapped atoms (indicated by the filled circles) spaced apart by regular intervals. In this step, the control apparatus implements two-qubit entangling gates between the nearest neighbors in the chain in three sub-steps. In the first sub-step (top row), the atoms in the chain are not entangled. Scanning laser beams across the chain from left to right creates entanglement (middle row), with the entanglement indicated by the line segments connecting adjacent atoms in the chain. This results in a state with nearest neighbor entanglement links (reach R=1) (bottom row).

In the next step, shown in FIG. 10B, the atoms are reshuffled, e.g., using trapping beams at a wavelength different than the gate/control beams. These trapping beams can be generated and directed by the control apparatus or by a different atom-trapping system. In this example, the eight atoms in the chain are reshuffled so that atoms 1, 3, 5, and 7 are moved to a first subarray and atoms 2, 4, 6, and 8 are moved to a second subarray. Once the atoms have been re-arranged into the subarrays, the control apparatus applies nearest-neighbor entangling gates between the first and second subarrays, establishing entanglement links of reach R=2 and putting the atoms in an R=1, 2 state. The reshuffling/entanglement steps shown in FIG. 10B can be repeated as desired until the atoms are in the desired order, e.g., to produce entanglement links of Rₙ=2ⁿ until n reaches floor(log₂(L−1)). In each step n, the atoms are reshuffled into Sₙ=min(Rₙ, L−Rₙ) subarrays. Then the control apparatus establishes nearest-neighbor connections between the atoms in each subarray. Three of these reshuffling and entanglement steps yields a cluster state in which each atom in the array is connected to at least three other atoms in the array, including at least two non-neighboring atoms, as shown in FIG. 10C.

### Other Applications

An inventive control apparatus can be used for applications other than controlling quantum systems, including display technology, LiDAR, microscopy, or other applications that (could) use a large number of modulated laser beams. For instance, an inventive control apparatus can display images with high resolution at high speeds (compared to, e.g., conventional laser beam scanning displays with a single modulated laser beam). It can also be used in a multibeam LiDAR system to scan over O(10⁶) points with O(10¹) kHz refresh rates, while simultaneously modulating the scanned beams to implement certain frequency or time domain multiplexing schemes. This capability is also useful for fluorescence microscopy.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An apparatus for controlling qubits in an array of qubits, the apparatus comprising:
lasers to emit laser beams in different wavelength channels;
modulators, in optical communication with the lasers, to temporally modulate the laser beams to perform a quantum operation on at least some of the qubits in the array of qubits;
a spatial light modulator (SLM), in optical communication with the modulators, to spatially modulate the laser beams based at least in part on the quantum operation; and
a beam scanner, in optical communication with the SLM, to scan the laser beams across the array of qubits at a scan rate faster than a reciprocal of a coherence time of the qubits.

2. The apparatus of claim 1, wherein the array of qubits comprises about 1,000 qubits to about 1,000,000 qubits.

3. The apparatus of claim 1, wherein the lasers are configured to emit the laser beams at wavelengths resonant with atomic transitions of the qubits.

4. The apparatus of claim 1, wherein the modulators are configured to temporally modulate the different wavelength channels independently of each other.

5. The apparatus of claim 1, wherein the modulators comprise micro-ring resonators arrayed along and evanescently coupled to a waveguide.

6. The apparatus of claim 1, wherein the modulators are configured to temporally modulate the laser beams at a rate of about 100 kHz to about 10 GHz and the beam scanner is configured to scan the laser beams across the array of qubits at a rate of about 1 kHz to about 1 MHz.

7. The apparatus of claim 1, wherein the SLM is configured to project the laser beams into arrays of laser beams spaced apart in a scan direction of the beam scanner by a spacing based on a lattice constant of the array of qubits.

8. The apparatus of claim 7, wherein the spacing is equal to the lattice constant of the array of qubits and the apparatus is configured to perform a two-qubit gate on nearest-neighbor qubits in the array of qubits.

9. The apparatus of claim 7, wherein the SLM is configured to vary the spacing between the arrays of laser beams between scans of the arrays of laser beams.

10. The apparatus of claim 1, wherein the beam scanner is configured to scan the laser beams across the array of qubits in a stepwise fashion.

11. A method of performing a quantum operation on qubits in an array of qubits, the method comprising:
emitting laser beams in different wavelength channels;
temporally modulating the laser beams to perform the quantum operation;
spatially modulating the laser beams based at least in part on the quantum operation; and
scanning the laser beams across the array of qubits at a scan rate faster than a reciprocal of a coherence time of the qubits.

12. The method of claim 11, wherein the array of qubits comprises about 1,000 qubits to about 1,000,000 qubits.

13. The method of claim 11, wherein emitting the laser beams comprises emitting the laser beams at wavelengths resonant with atomic transitions of the qubits.

14. The method of claim 11, wherein temporally modulating the laser beams comprises temporally modulating the different wavelength channels independently of each other.

15. The method of claim 11, wherein temporally modulating the laser beams occurs at a rate of about 100 kHz to about 10 GHz and scanning the laser beams across the array of qubits occurs at a rate of about 1 kHz to about 1 MHz.

16. The method of claim 11, wherein spatially modulating the laser beams comprises projecting the laser beams into two columns of laser beams spaced apart in a direction of the scanning by a spacing based on a lattice constant of the array of qubits.

17. The method of claim 16, wherein the spacing is equal to the lattice constant of the array of qubits and the quantum operation is a two-qubit gate performed on nearest-neighbor qubits.

18. The method of claim 16, further comprising:
varying the spacing between the two columns of laser beams between scans of the two columns of laser beams.

19. The method of claim 11, wherein scanning the laser beams occurs in a stepwise fashion.

20. The method of claim 11, wherein the qubits comprise trapped ions or atoms, and further comprising:
moving at least one of the trapped ions or qubits within the array of qubits.
